(19) United States
(12) Patent Application Publication
(10) Pub. No.: US 2015/0177160 A1
(43) Pub. Date: Jun. 25, 2015

(54) Non-Imaging Coherent Line Scanner Systems and Methods for Optical Inspection

(71) Applicant: CORNING INCORPORATED, CORNING, NY (US)

(72) Inventor: Leon Robert Zoeller, III, Hammondsport, NY (US)

(21) Appl. No.: 14/573,157

(22) Filed: Dec. 17, 2014

Related U.S. Application Data
(60) Provisional application No. 61/919,959, filed on Dec. 23, 2013.

(51) Int. Cl. G01N 21/892; G01N 21/958

(52) U.S. Cl. CPC G01N 21/892; G01N 21/958

(57) ABSTRACT

Non-imaging coherent line scanner systems for measuring at least one defect in a transparent sheet are disclosed. The systems include a laser system that generates coherent diverging laser-line beam, and a cylindrical optical system that forms therefrom a collimated laser-line beam. A movable support member supports and moves the transparent sheet so that the collimated laser-line beam scans the transparent sheet and passes through a portion of the transparent sheet and the at least one defect during scanning. A line-scan sensor system receives the transmitted collimated laser-line beam and a portion of the beam redirected by the defect. The result is an interference image that has at least one coherent defect signature representative of the at least one defect in the transparent object.

This application claims the benefit of priority under 35 U.S.C. § 119 of U.S. Provisional Application Ser. No. 61/919959 filed on Dec. 23, 2013 the content of which is relied upon and incorporated herein by reference in its entirety.

### FIELD

The present disclosure relates to optical inspection, and in particular relates to non-imaging coherent line scanner systems for and methods of performing optical inspection of transparent objects such as transparent sheets, including curved transparent sheets.

### BACKGROUND

Optical inspection systems and methods are used to inspect a variety of different types of objects to assess whether the objects meet certain manufacturing specifications. The most common type of optical inspection system forms an image of the object and then analyzes the image, e.g., performs image-processing on the image. Many image-forming optical inspection systems are relatively complex, e.g., utilize angled optical paths and a relatively large number of optical components to perform the imaging. Also, many image-forming optical inspection systems are designed to measure objects that have flat surfaces.

One type of object that has proven difficult to optically inspect is a curved transparent sheet such as a glass sheet. The curved surfaces require the use of large depth-of-field imaging system. Moreover, if the curved transparent sheet is large, trying to capture an image of the entire curved transparent sheet is difficult. Furthermore, the resolution of the imaging system often needs to be high to inspect for very small defects, e.g., as small as 5 μm. Unfortunately, a high imaging resolution also means a relatively shallow depth of field (e.g., about ±50 microns), which is much smaller than the thickness of a typical transparent sheet, especially a curved transparent sheet.

### SUMMARY

An aspect of the disclosure is a non-imaging coherent line scanner system for measuring at least one defect in a transparent sheet having front and back surfaces. The system consists of in order along an optical axis: a laser system that generates a coherent diverging laser-line beam in a direction along the optical axis; a cylindrical optical system arranged along the optical axis and that receives the diverging laser-line beam and forms therefrom a collimated laser-line beam; a movable support member arranged adjacent and downstream of the cylindrical optical system and adapted to support and move the transparent sheet relative to the collimated laser-line beam so that the collimated laser-line beam passes through a portion of the transparent sheet and the at least one defect as the transparent sheet is translated in direction generally perpendicular to the optical axis; and a line-scan sensor system arranged along the optical axis and downstream of the movable support member to receive the collimated laser-line beam as transmitted through the transparent object and through the at least one defect to generate an interference image that has at least one coherent defect signature representative of the at least one defect in the transparent object.

Another aspect of the disclosure is the non-imaging coherent line scanner system described above, wherein the line-scan sensor system includes a line-scan sensor operably connected to a frame grabber, and wherein the line-scan sensor captures linear digital frames and the frame grabber coordinates the capturing of the linear digital frames with the movement of the transparent sheet.

Another aspect of the disclosure is the non-imaging coherent line scanner system described above, wherein the line-scan sensor system further includes a computer operably connected to the frame grabber and that assembles the linear digital frames from the frame grabber to form the interference image. In an example, the computer is configured with instructions embodied in a computer-readable medium that cause the computer to form the interference image from the linear digital frames and process the at least one coherent defect signature of the interference image to calculate an amount of optical power redistribution caused by the at least one defect. In an example, the computer is configured with instructions embodied in a computer-readable medium determine one or more characteristics of the at least one defect based on the at least one coherent defect signature. This characterization can include reference to a database of coherent defect signatures from previously characterized defects.

Another aspect of the disclosure is a non-imaging coherent line-scanner system for characterizing at least one defect of a transparent sheet. The system consists essentially of in order along an optical axis: a laser system that generates a coherent diverging laser-line beam along an optical axis; a cylindrical optical system arranged along the optical axis and that receives the diverging laser-line beam and forms therefrom a collimated laser-line beam; a movable support member adapted to support and move the transparent sheet in a direction generally perpendicular to the optical axis; and a line-scan sensor system arranged relative to the movable support member to define a working space, the line-scan sensor system being adapted to receive the collimated laser-line beam as transmitted through the transparent sheet and through the at least one defect without passing through any optical elements with power in the working space, and form from the transmitted collimated laser-line beam an interference image having at least one coherent defect signature corresponding to the at least one defect.

Another aspect of the disclosure is a non-imaging method of detecting (or detecting and characterizing) at least one defect in a transparent sheet. The method includes: transmitting a coherent laser-line beam through the transparent sheet while translating the transparent sheet in a direction generally perpendicular to the laser-line beam; receiving and detecting the transmitted coherent laser-line beam with a line-scan sensor system that defines a working space between the line-scan sensor system and the transparent sheet, wherein the transmitted coherent laser-line beam passes through the at least one defect and the working space so that the line-scan sensor system forms an interference image that includes at least one coherent defect signature, and wherein there are no optical components that have optical power within the working space; and determining from the at least one coherent defect signature one or more characteristics of the at least one defect.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated into and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying Figures, in which:

FIG. 1A is an elevated view of an example transparent sheet that has front and back curved surfaces;

FIG. 1B is a cross-sectional view of the transparent sheet of FIG. 1A as taken along the line a-a, showing an example sheet having substantially concentric top and bottom surfaces;

FIG. 2 is a schematic diagram of an example embodiment of a non-imaging coherent line scanner system for optically inspecting a transparent sheet such as shown in FIGS. 1A and 1B;

FIG. 3 is a front-on view of the transparent sheet as movably supported by a movable stage that translates in the x-direction along a rail to effectuate scanning of the collimated laser-line beam relative to the transparent sheet;

FIG. 4 is a schematic diagram of an example interference image as captured by the non-imaging coherent line scanner system of FIG. 3 and that shows two example coherent defect signatures;

FIG. 5 is a close-up view of a coherent defect signature of an actual interference image as captured using an example non-imaging coherent line scanner system that employed a single plano-convex lens element as the cylindrical optical system;

FIG. 6 is a close-up schematic diagram of an example transparent sheet along with the collimated laser-line beam and its substantially planar wavefronts, the transmitted laser beam and its reference wavefronts, and the redirected light portion and its wavefronts, illustrating how the distance from the transparent sheet to the sensor plane changes the size of the coherent defect signature recorded at the sensor plane;

FIG. 7A is a schematic plot of intensity I(x) versus interference image location x for a cross-section of an example interference image, showing how an example coherent defect signature redistributes the optical energy relative to a background intensity I_{BG}, and how this energy redistribution can be used to detect and characterize the defect;

FIG. 7B is a plot of intensity I(x) versus interference image location x similar to FIG. 7A for an actual interference image that shows two coherent defect signatures and the background intensity I_{BG};

FIG. 8 is a front-on view of an example display that includes an example graphical representation of measured defects shown in relation to a graphical representation of the transparent sheet; and

FIGS. 9A and 9B illustrate an example embodiment of the non-imaging coherent line scanner system wherein there is no cylindrical optical system.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

The claims as set forth below are incorporated into and constitute part of this detailed description.

The entire disclosure of any publication or patent document mentioned herein is incorporated by reference.

Cartesian coordinates are shown in some of the Figures for the sake of reference and are not intended to be limiting as to direction or orientation.

The terms “downstream” and “upstream” are used herein to indicate the relative location of an item relative to the direction of the travel of light, wherein when item B is downstream of item A, light is incident first upon item A and then is incident upon item B. In this case, item A can be said to be upstream of item B.

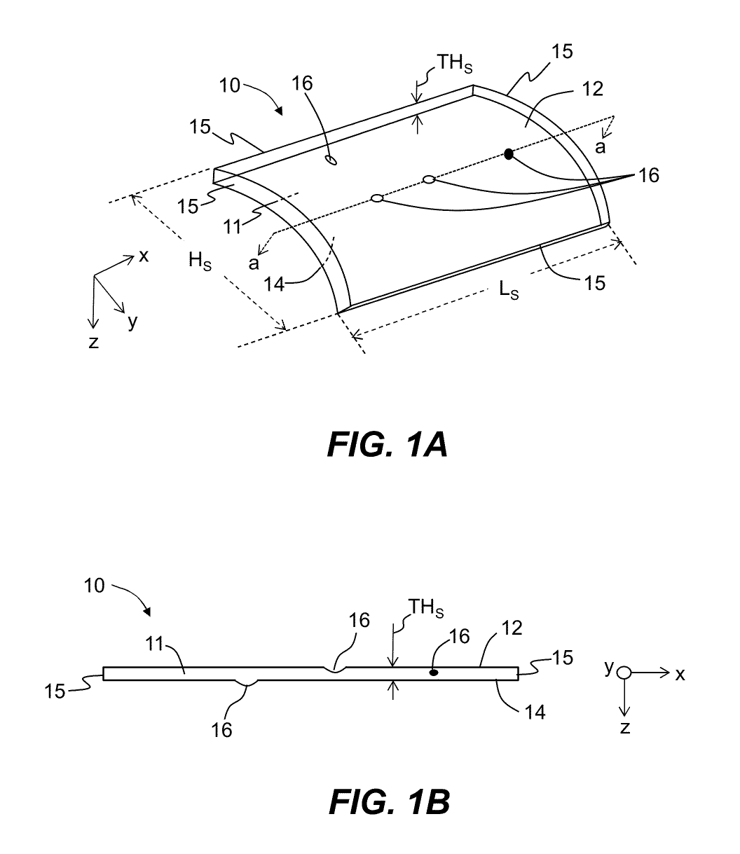

FIG. 1A is an elevated view of an example transparent sheet 10. Transparent sheet 10 has a body 11 with opposite front and back surfaces 12 and 14 and outer edges 15. In one example, front and back surfaces 12 and 14 can be planar and substantially parallel to one another, while other examples one or both of the front and back surfaces can have a curvature. In an example, front and back surfaces 12 and 14 have substantially concentric curvatures, such as shown the example transparent sheet of FIG. 1A. For such a case, a cross-section of the transparent sheet in one direction shows the front and back surfaces 12 and 14 as being substantially parallel, e.g., as shown in the cross-sectional view of FIG. 1B, which is taken along the line a-a in FIG. 1A.

In other examples, one or both of front and back surfaces 12 and 14 have a curvature in one direction. Such a transparent sheet can have a substantially constant thickness TH_{S}. Other example transparent sheets 10 can have a varying thickness TH_{S}.

In an example, transparent sheet 10 is made of glass, such as chemically strengthened glass. An example of a chemically strengthened class is Gorilla® Glass, which is made by Corning, Inc., of Corning, New York. Other examples of transparent sheet 10 are made of clear plastics, thermoplastics, polymers, resins, glass laminates, etc., and generally any transparent material that can be formed as a sheet.

FIGS. 1A and 1B show an example defect 16 that resides on front surface 12. Other defects 16 may reside on or in front surface 12 as well on or in back surface 14. Defects 16 may also reside within body 11, as shown in FIG. 1B, e.g., as an inclusion, bubble, etc. FIG. 1B also shows a bump defect 16 on front surface 12 as well as an indentation or dimple defect on back surface 14. Defects 16 can generally include bumps, depressions, indents, dimples, bubbles, inclusions, surface dirt, particles, etc.

Transparent sheet 10 can have a variety of different shapes. The example transparent sheet 10 of FIG. 1A and 1B has a length L_{S}, a height H_{S} and the aforementioned thickness TH_{S}. The curvatures of front and back surfaces 12 and 14 need not be spherical and can be aspherical, e.g., transparent sheet 10 can be cylindrical, toroidal, etc. In an example, the front and back surfaces 12 and 14 are substantially concentric cylindrical surfaces that in one example differ from being parallel (see, e.g., FIG. 1B) by no more than 5% and in another example differ by no more than 2% and in another example differ by no more than 1%.

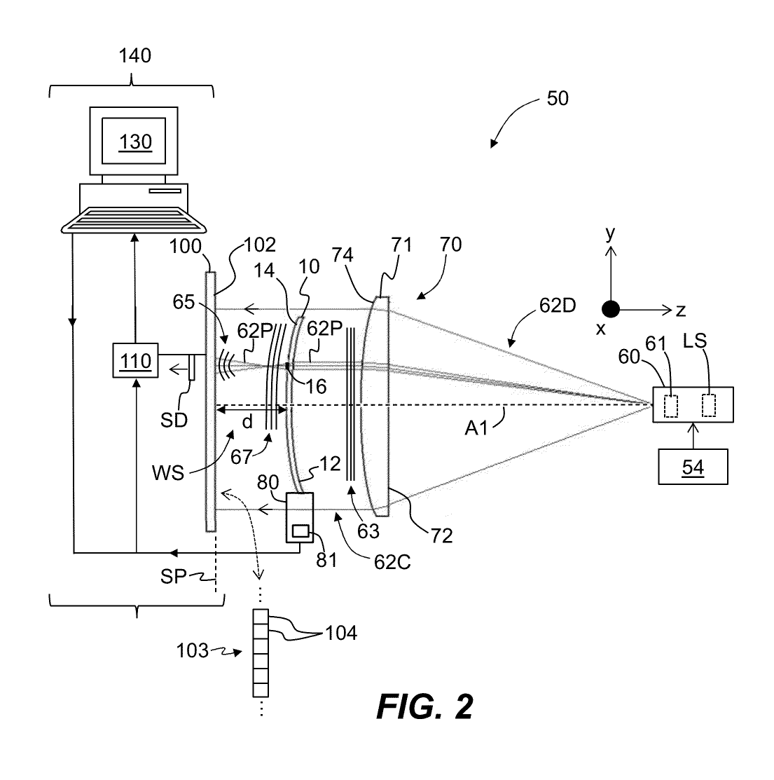

FIG. 2 is a schematic diagram of an example non-imaging coherent line-scanning system (“system”) 50 for performing optical inspection of transparent sheet 10. System 50 has an optical axis A1 that runs in the z-direction. System 50 includes a laser system 60 arranged along optical axis A1. In an example, laser system 60 includes a laser source LS and one or more optical elements 61 arranged so that the laser system emits a narrow coherent diverging laser-line beam 62D that diverges in the y-direction and that is substantially collimated in the x-direction. An example laser source LS includes at least one diode laser. Other types of lasers can also be employed as laser source LS.

In an example, diverging laser-line beam 62D has a beam width W_{B} in the x-direction of about 0.25″ or 0.5″ or about 0.375″. In an example, the one or more optical elements 61 that give rise to diverging laser-line beam 62D can be arranged immediately downstream of laser system 60. In the example system 50 of FIG. 2, the one or more optical elements 61 are internal to laser system 60.

System 50 also includes a cylindrical optical system 70 arranged along optical axis A1 and downstream of laser system 60 and configured to receive diverging laser-line beam 62D. In an example, cylindrical optical system 70 consists of a single optical element 71. An example single optical element 71 is a plano-convex cylindrical lens having front and back surfaces 72 and 74. In an example, the plano-convex cylindrical lens has a planar front surface 72 that faces laser source 60, and a convex back surface 74. Cylindrical optical system 70 can generally include one or more optical elements that are configured to perform beam collimation in on direction, such as the y-direction as shown in FIG. 2. An advantage of using a single plano-convex cylindrical lens 71 such as shown in FIG. 2 is that it makes system 50 simple, inexpensive, compact and easy to implement.

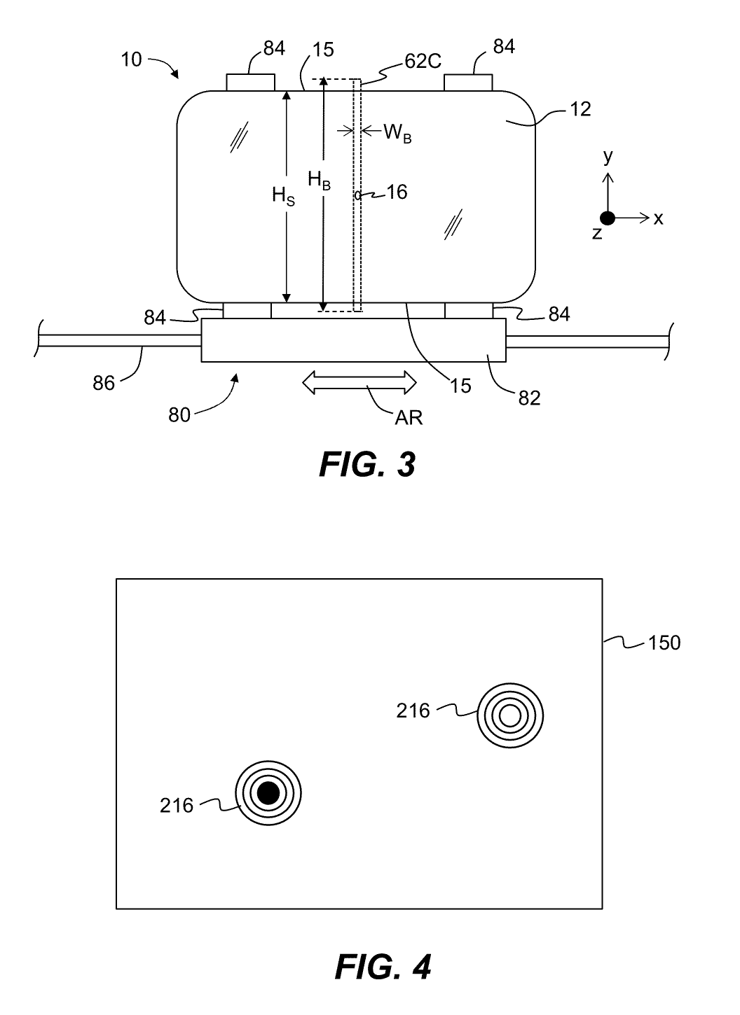

FIG. 3 is a front-on view of a movable support member 80 that resides adjacent and spaced apart from back surface 74 of cylindrical optical system 70. Movable support member 80 is configured to operably support (e.g., hold) transparent sheet 10 and move the transparent sheet in the x-direction, i.e., substantially perpendicular to optical axis A1 in either direction. In an example, movable support member 80 includes a base 82 and one or more holding features 84 configured to hold transparent sheet 10. In an example, holding features 84 are configured to grip opposite edges 15 of transparent sheet 10 so that only a very small portion or no portion of front and back surfaces 12 and 14 are obscured. In an example, movable support member 80 comprises a translation stage with precision positioning capability.

In an example, base 82 is configured to move in the +x and −x directions (as indicated by arrow AR) along a rail 86. In an example, the position of movable support member 80 can also be adjusted in the z-direction and the y-direction. An exemplary movable support member 80 includes a position-measuring device 81 (e.g., a linear encoder; see FIG. 2) that measures the position of the movable support member relative to a reference position (e.g., axis A1).

With reference again to FIG. 2, system 50 also includes a line-scan sensor 100 arranged along optical axis A1 and downstream of movable support member 80. Line-scan sensor 100 has a photosensitive surface 102 that in an example includes a single column 103 of pixels 104, as shown in the close-up inset of FIG. 2. Photosensitive surface 102 is arranged to lie in a sensor plane SP.

Note that system 50 has no optical components that have optical power between movable support member 80 and line-scan sensor 100, i.e., in a working space WS between transparent sheet 10 and the line-scan sensor when the transparent sheet is supported on the movable support member. In another example, there are no optical components at all (i.e., even those with no optical power, such as plates, planar filters, etc.) within working space WS. Line-scan sensor 100 resides at an axial working distance d from the back surface 14 of transparent sheet 10 when the transparent sheet is supported by movable support member 80. In an example, working distance d is in the range from 0.5 cm≦d≦100 cm. In an example, working distance d is adjusted by axially moving at least one of movable support member 80 and line-scan sensor 100.

System 50 also includes a frame grabber 110 operably (e.g., electrically) connected to line-scan sensor 100. System 50 further includes a computer 130 operably (e.g., electrically) connected to the frame grabber. An example line-scan sensor 100 has 12,000 5.2 μm pixels 104, a 90 kHz line rate and a 1 gigapixel throughput. An example of such a line-scan sensor is available from Teledyne DALSA, Ontario, Canada. An example frame grabber 110 is the Xcelera-HS PX8 Teledyne frame grabber, also available from Teledyne DALSA. An example computer 130 is a personal computer or a workstation that is programmable to execute instructions stored in firmware and/or software (i.e., embodied in a computer-readable medium) to cause the computer to carry out the processing of digital frames from frame grabber 110, as described below. Line-scan sensor 100, frame grabber 110 and computer 130 constitute an example of a line-scan sensor system 140.

In the operation of system 50, laser system 60 generates the aforementioned diverging laser-line beam 62D, which travels generally along axis A1 towards cylindrical optical system 70. The cylindrical optical system 70 has power in the y-direction such that it forms a narrow, substantially collimated laser beam 62C, wherein the collimation is now in both the x-direction and y-direction, i.e., is fully collimated. In an example, collimated laser-line beam 62C has a beam height H_{B}>H_{S} (see FIG. 3). Exemplary beam heights H_{B} are in the range 2″≦H_{B}≦12″, although other beam heights outside of this range can be used depending on the height H_{S} of transparent sheet 10. In another example embodiment, collimated laser-line beam 62C can have a beam height H_{B}<H_{S} but such a laser beam will only measure a portion of transparent sheet 10. An exemplary beam height H_{S} is about 3″.

In an example, collimated laser-line beam 62C has the aforementioned width W_{B}, which in an example is at least as wide as that of the line-scan sensor 100, and in an example is substantially wider for ease of alignment. For example, for a line-scan sensor 100 having pixels 104 of width 5.2 μm, a beam width W_{B} of 0.25″=6.35 mm was used, which made for easy alignment of collimated laser-line beam 62C with line-scan sensor 100. Another consideration for the beam width W_{B} is the amount of optical power or energy density required at line-scan sensor 100. An example aspect ratio RA of collimated laser-line beam 62C can be defined as RA=H_{B}/W_{B}. In an example, a practical lower value on RA is 2″/0.5″=4 and a practical upper value is 12″/0.25″=48. However, in other examples, RA can be as low as 2 and can be as high as 100 or 1000 or 50,000 or 100,000, and the actual aspect ratio will depend on a number of factors such as desired optical power, size of pixels 104, the desired ease of alignment, the height H_{S} of transparent sheet 10, etc.

Collimated laser-line beam 62C is incident upon transparent sheet 10, which is moving in the x-direction so that the collimated laser-line beam scans the transparent sheet. The collimated laser-line beam 10 passes through transparent sheet 10 and continues on to line-scan sensor 100. If transparent sheet 10 has no defects 16, then the intensity of the light reaching transparent sheet 10 is substantially uniform or has some degree of non-uniformity that is attributable to other sources besides defects, such as from cylindrical optical system 70, large-scale transmission variations in transparent sheet 10, etc. In an example embodiment, intensity measurements can be taken with system 50 either without transparent sheet 10 present or with a defect-free transparent sheet to establish an intensity baseline or background intensity reading.

Line-scan sensor 100 receives the transmitted collimated laser-line beam 62C transmitted through transparent sheet 10 and in response generates corresponding electrical detector signals SD. In an example, detector signals SD constitute a digital video stream of linear digital frames. Detector signals SD are sent to frame grabber 110, which captures the linear digital frames and optionally compresses the frames. The linear digital frames are then sent on to computer 130 for processing, as described below.

In an example, line-scan sensor 100 and frame grabber 110 are configured to perform time delay integration (TDI). Examples of TDI are discussed in U.S. Pat. No. 6,906,749, and in the article by He et al., entitled “Time delay integration speeds up imaging,” Photonics Spectra, May 2012. An advantage of using TDI is that the amount of light needed for operation of system 50 can be reduced by about an order of magnitude. In an example embodiment, line-scan sensor 100 can include multiple columns 103 of pixels 104, e.g., when using system 50 in TDI mode.

In an example, the speed (“line speed”) SL at which transparent sheet 10 is translated relative to collimated laser-line beam 62C is in the range 20 cm/s≦SL≦50 cm/s. As noted above, an example line-scan sensor 100 can capture up to 90K frames/second. The line speed SL is the number of scans per second (or the number of frames per second) times the size of pixels 104. This is true even when system 50 is configured to perform TDI. TDI sensors contain all of the circuitry to concurrently shift charge from each row 103 of pixels 104 to its neighboring row of pixels automatically and synchronously with the scan rate clock so it looks like a single-row scan device to all external hardware, such as frame grabber 110. Thus, for a frame rate of 40K frames/second, the line speed SL=40K·5.2 μm=208000 μm/s=20.8 cm/s. For a frame rate of 90K frames/second, then the line speed is SL=90K·5.2 μm=468000 μm/s=46.8 cm/s.

Computer 130 receives and processes the (linear) digital frames from frame grabber 110. Specifically, computer 130 assembles the digital frames to form a 2D “interference image,” which is explained below. In an example where square pixels 104 are maintained, the line-scan speed of line-scan sensor 100 and the translation speed of transparent sheet 10 are coordinated. The coordinated capture of linear digital frames is accomplished by providing motion data from position measuring device 81 of movable support member 80 to frame grabber 110.

With continuing reference to FIG. 2, if transparent sheet 10 has a defect 16, then a portion 62P of the light in collimated laser-line beam 62C (which has substantially planar wavefronts 63) will be redirected by the defect in a manner that corresponds to the size, shape and material of the defect. The redirected light portion 62P has associated “defect” wavefronts 65, while the other light passing through transparent sheet 10 that originally had planar wavefronts 63 now has wavefronts 67 with a shape defined by transparent sheet 10. Because the light making up collimated light beam 62C is coherent, the two sets of wavefronts 65 and 67 interfere at line-scan sensor 100, with wavefronts 67 serving as “reference” wavefronts.

When transparent sheet 10 is substantially planar, than reference wavefronts 67 will be substantially planar. When transparent sheet 10 is substantially curved, then reference wavefronts 67 will be substantially curved. However, the curvature of reference wavefronts 67 will generally be much less than the curvature of defect wavefronts 65 generated by defect 16. Moreover, the linear extent (in the y-direction) of defect wavefronts 65 at line-scan sensor 100 is relatively small (e.g., on the order of hundreds of microns) so that the reference wavefronts 67 can usually be considered as being substantially planar over this distance.

As discussed above, computer 130 assembles the linear digital frames from frame grabber 110 to form the aforementioned interference image. The interference image is not a conventional image, i.e., it is not formed by optics that form an image of an object at an image plane. Rather, it is recordation of interfering defect and reference wavefronts 65 and 67. There are no optical elements in system 50 that act to form an image at line-scan sensor 100 in the conventional sense.

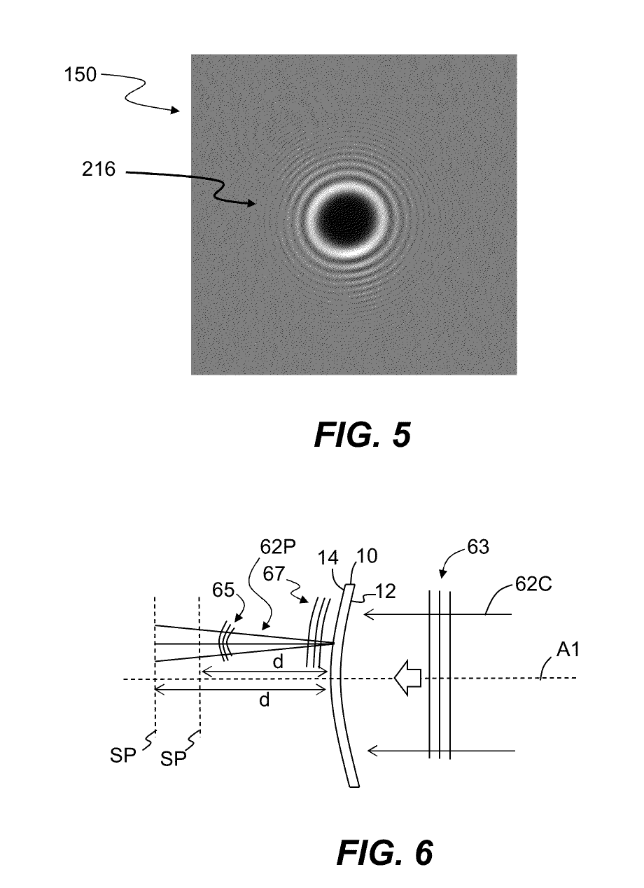

FIG. 4 is a schematic diagram of an example interference image 150 formed by computer 130. Interference image 150 includes two coherent defect signatures 216 that correspond to two defects 16 in or on transparent sheet 10. FIG. 5 is a portion of an actual interference image 150 obtained using an example system 50 that utilized a single plano-convex cylindrical lens 71 for cylindrical optical system 70. The coherent defect signature 216 of the interference image of FIG. 5 resembles the one shown in FIG. 4 on the left side of the interference image in that it has a dark center surrounded by bright and dark rings.

The size and shape of the coherent defect signature 216 can be evaluated and used to determine the size and shape of the corresponding defect 16. For example, the coherent defect signature 216 on the left side of interference image 150 and shown in close-up in FIG. 5 has a dark center, which can be indicative of a defect 16 in the form of a depression, indentation, dimple, etc. Such a defect 16 acts like a miniature negative lens that disperses light, thereby resulting in the dark center.

Likewise, the coherent defect signature 216 on the right side of interference image 150 has a bright center, which can be indicative of a defect 16 in the form of a bump. Such a defect 16 acts to concentrate light, thereby resulting in the bright center. The round shape of the two coherent defect signatures 216 indicate that the corresponding defects also have a round shape, or are so small that they are essentially point-like defects.

By knowing the working distance d between the transparent sheet 10 and line-scan sensor 100, the shape of transparent sheet 10 and the wavelength λ of light 62 emitted by laser system 60, the size and shape of the corresponding defect 16 can be determined to a reasonable degree of accuracy using standard interference and diffraction methods known in the art of optics. As noted above, in many cases transparent sheet 10 can be approximated by a planar sheet since in many instances the reference wavefronts 67 can be considered planar over the small sections of the wavefronts that actually interfere with wavefronts 65 associated with redirected light portion 62P.

For example, notice that the right-hand coherent defect signature 216 of FIG. 4 resembles an Airy diffraction pattern of the focus spot of an imaging system having a round aperture. The equation that relates the distance r from the center out to the first ring in the Airy diffraction pattern to the working distance d of the aperture and the width D of the aperture and the imaging wavelength λ is r=1.22 dλ/D. In system 50, the parameters d and λ are known, with r being measured from the interference image 150. The diameter D corresponds to the size (diameter) of defect 16 and the working distance d is the (approximate) distance from the defect to the photosensitive surface 102 of line-scan sensor 100.

Thus, if a coherent defect signature 216 has a central disk measured to have a radius r=100 μm, then if the wavelength λ=0.633 μm (the HeNe laser wavelength), and the working distance d is taken as 2 cm=2×10⁴ μm, then the diameter D of defect 16 is approximately given by D=1.22 dλ/r=(1.22)(2×10⁴ μm)(0.633 μm)/(100 μm)=154 μm. Thus, the simple approximate equation for the Airy pattern represents one method of estimating the size and shape of defects 16. More rigorous diffraction-based methods can also be used.

FIG. 6 is a close-up schematic diagram of system 50 showing transparent sheet 10, collimated laser-line beam 62C and its planar wavefronts 63, the reference wavefronts 67 formed by planar wavefronts passing through the transparent sheet, and the redirected or defect wavefronts 65 associated with redirected light portion 62P. Also shown are two different working distances d for the sensor plane SP. As the working distance d gets larger, the size of the coherent defect signature 216 gets larger, but its intensity gets smaller. Thus, the working distance d can be selected to ensure that the coherent defect signatures 216 have a size that falls into a select range when looking for defects 16 having a size within a corresponding select range. The working distance d can also be select so that the coherent defect signature 216 has a select intensity or a minimum threshold intensity.

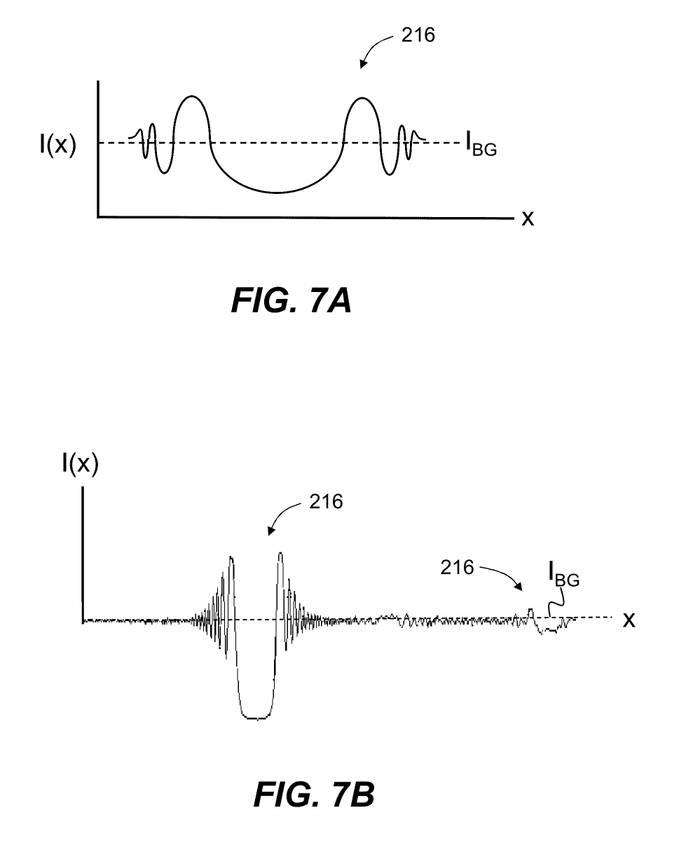

FIG. 7A is a schematic plot of the intensity I(x) versus the distance x for a cross-section of an example coherent defect signature 216 such as shown in FIG. 6. The plot of FIG. 7A shows how redirected light portion 62P redistributes the light energy at sensor plane SP and thus over line-scan sensor 100. Also shown in FIG. 7A is a background or reference intensity I_{BG}. As discussed above, the background intensity I_{BG} can be measured without transparent sheet 10 present, or with a known (reference) calibration transparent sheet, e.g., one that has no defects. In an example, computer 130 is configured to process interference image 150 to determine the amount of optical power that has been redistributed. For example, computer 130 can be configured (e.g., via instructions embodied in a computer readable medium) to perform a one-dimensional or two-dimensional integration to find the amount of area under the intensity curve (I(x) or I(x,y)) relative to the background intensity I_{BG}.

FIG. 7B is similar to FIG. 7A and is a plot of intensity I(x) versus x for data obtained from an actual interference image 150 taken using an example system 50 that employed a single plano-convex cylindrical lens 71 for cylindrical optical system 70. Notice in FIG. 7B that there is one relatively large coherent defect signature 216 and one relatively small coherent defect signature, with some slight variations in the intensity with respect to the background intensity I_{BG} in between the two coherent defect signatures.

In the case where intensity is defined as watts/m², the integration of the two-dimensional intensity I(x,y) of the coherent defect signature 216 yields an amount of redistributed optical power in watts=Joules/second associated with the coherent defect signature. The amount of measured power can be used to characterize defects 16, with “stronger” (i.e., larger) defects causing larger amounts of redistributed power. In an example, the amount of redistributed optical power must exceed a certain threshold for the corresponding defect 216 to be considered significant.

Thus, an example method of performing optical inspection of transparent sheet 10 using system 50 includes the following basic steps. The first step is a calibration step. This step can include performing the aforementioned background calibration to obtain the background intensity I_{BG}. This step can also include gain and dark current calibration (i.e., zeroing out) of the line-scan sensor 100, and setting the amount of laser power to be used. In an example embodiment, the amount of power in collimated laser-line beam 62C is set to be about ½ the saturation level of line-scan sensor 100. In an example, laser system 60 has a maximum output power of 50 mW. The amount of output power can be adjusted by a power supply 54 connected to the laser, and optionally to computer 130 (see FIG. 2).

The second step includes scanning transparent sheet 10 with collimated laser-line beam 62C as described above to capture digital frames with line-scan sensor 100 and frame grabber 110.

The third step includes processing (assembling) the digital frames using computer 130 to obtain an interference image 150 that includes one or more coherent defect signatures 216.

The fourth step includes processing the coherent defect signatures 216 in the interference image 150 to detect and characterize the one or more defects 16 that gave rise to the coherent defect signatures. The characterization can include at least one of size, shape, type (e.g., bumps, depressions, indents, dimples, bubbles, inclusions, surface dirt, particles, etc.), location (including z location, i.e., surface or internal defect), number, and distribution (e.g., defect map, size distributions, etc.). In an example, computer 130 also processes the interference image to establish one or more edges 15 of transparent sheet 10 to serve as a reference for locating the one or more defects 16. The method can also include computer 130 displaying the results of the defect characterization to an end-user, e.g., via a graphic display, as discussed below.

In an example embodiment, a variety of different types and sizes of coherent defect signatures 216 can be detected and measured and then the corresponding defects 16 measured directly (e.g., using a microscope, interferometer, profilometer, etc.) to create a database that correlates coherent defect signatures 216 to known types and sizes of defects 16. This database can be included in computer 130 to assist in the processing of interference image 150 and to facilitate the characterization of defects based on their coherent defect signatures. In an example, defects 16 can be characterized by a numbering system or scale based on their severity. In an example, computer 130 includes instructions embodied in a computer-readable medium (e.g., software) the causes the computer to process the interference image and perform the above-described defect detection and characterization.

In an example embodiment, transparent sheet 10 can be rotated (e.g., by 90 degrees) and re-measured and then the corresponding rotated interference images 150 analyzed and compared to correlate the measured defects 216 for the non-rotated and rotated measurements. This aspect of the optical inspection method reduces the number of false detections of defects.

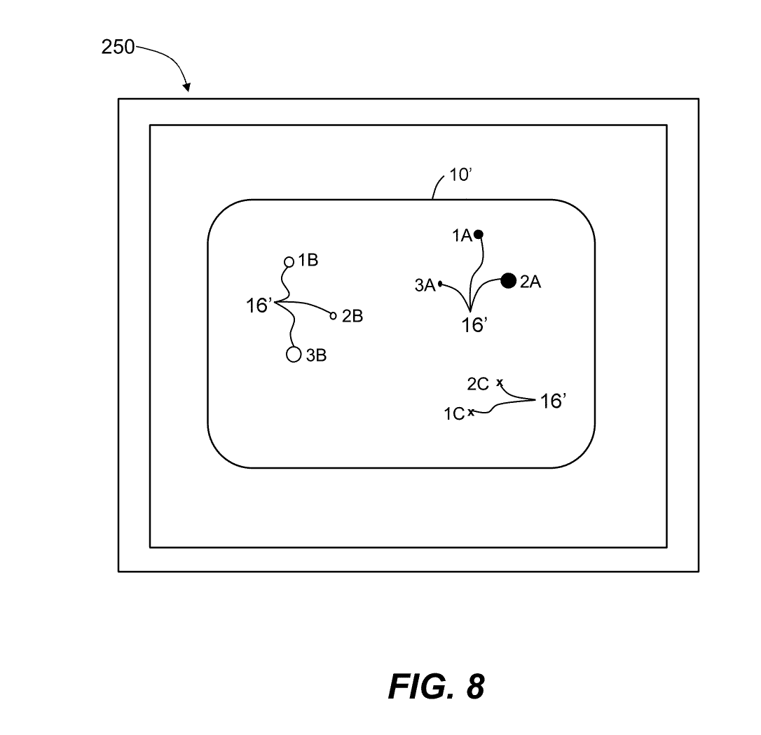

FIG. 8 is a front-on view of a display 250 that includes example graphical representations 16′ of defects 16 shown in relation to a graphical representation 10′ of transparent sheet 10.

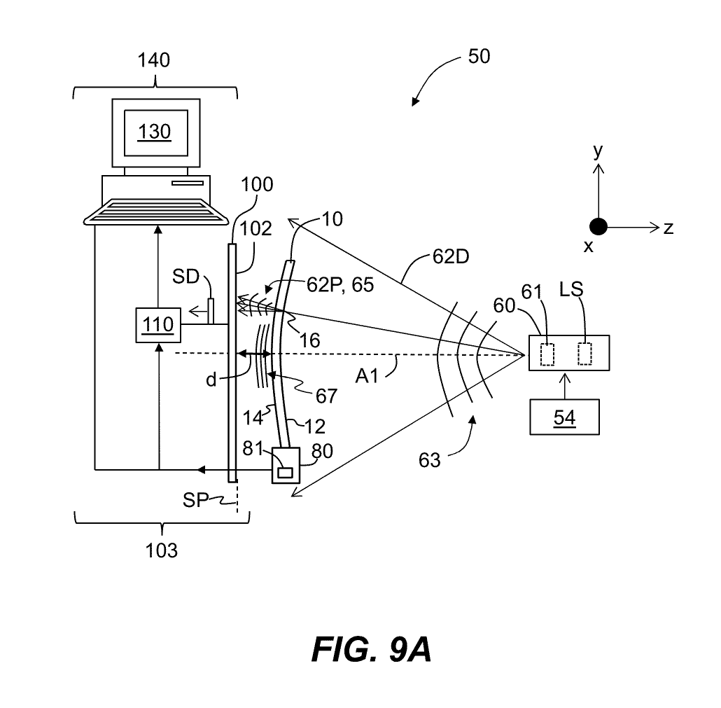

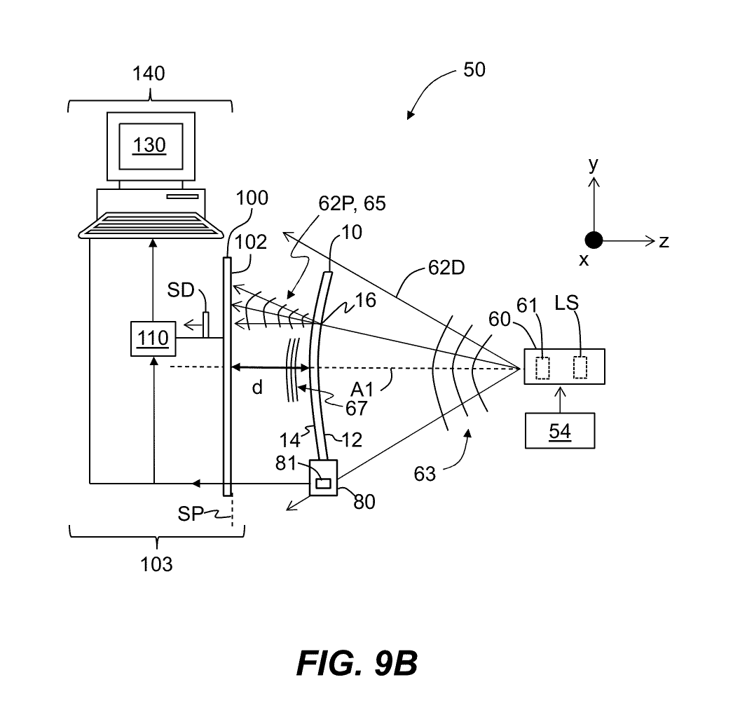

FIGS. 9A and 9B illustrate an example embodiment of an example system 50 that does not include cylindrical optical system 70. FIG. 9A shows transparent sheet closer to line-scan sensor 100 than in FIG. 9B. In the configurations of system 50 shown in FIGS. 9A and 9B, wavefronts 63 are not planar and instead are substantially cylindrical. Thus, rather than using a fully collimated laser-line beam 62C, the diverging laser-line beam 62D (which is only collimated in the x-direction) is used.

Diverging laser-line beam 62D with wavefronts 63 thus travels uninterrupted from laser system 60 to transparent sheet 10, wherein a portion of the beam interacts with defect 16, thereby generated deflected light 62P with defect wavefronts 65. The non-deflected portion of diverging laser-line beam 62D transmitted by transparent sheet 10 has reference wavefronts 67 (only a central section of reference wavefronts 67 are shown for ease of illustration). Diverging laser-line beam 62D can have a width W_{B} the same as discussed above in connection with collimated laser-line beam 62C.

Thus, as described above in connection with the embodiment where collimated laser-line beam 62C was used, defect 16 causes a portion 62P of diverging laser-line beam 62D and the corresponding defect wavefronts 65 to be redirected by the defect in a manner that corresponds to the size, shape and material of the defect. Deflected light portion 65P is detected via the interference of defect and reference wavefronts 65 and 67 at line-scan sensor 100. The detection occurs over a region centered on a given y-location that depends on the working distance d, as can be seen by comparing FIGS. 9A and 9B.

In FIG. 9B, the larger working distance d results in the center of the deflected light portion (e.g., the centroid) being located at a higher y position, with the deflected light portion 62P also spread out over a larger portion of line-scan sensor 100. If the working distance d is kept the same, then there is no need to compensate for this displacement effect, which does not occur in the embodiments described above that utilizes cylindrical optical system 70 and thus collimated laser-line beam 62C.

The coherent defect signatures 216 obtained by the example system 50 of FIGS. 9A and 9B are processed in essentially the same manner and methods as described above in connection with system 50 that utilizes cylindrical optical system 70, taking into account the divergence of the diverging laser-line beam 62D. The calibration of system 50 can also be performed in essentially the same manner as described above in connection with system 50 that utilizes cylindrical optical system 70.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A non-imaging coherent line scanner system for measuring at least one defect in a transparent sheet having front and back surfaces, consisting of in order along an optical axis:
a laser system that generates a coherent diverging laser-line beam in a direction along the optical axis;
a cylindrical optical system arranged along the optical axis and that receives the diverging laser-line beam and forms therefrom a collimated laser-line beam;
a movable support member arranged adjacent and downstream of the cylindrical optical system and adapted to support and move the transparent sheet relative to the collimated laser-line beam so that the collimated laser-line beam passes through a portion of the transparent sheet and the at least one defect as the transparent sheet is translated in direction generally perpendicular to the optical axis; and
a line-scan sensor system arranged along the optical axis and downstream of the movable support member to receive the collimated laser-line beam as transmitted through the transparent object and through the at least one defect to generate an interference image that has at least one coherent defect signature representative of the at least one defect in the transparent object.

2. The system of claim 1, wherein the line-scan sensor system includes a line-scan sensor operably connected to a frame grabber, and wherein the line-scan sensor captures linear digital frames and the frame grabber coordinates the capturing of the linear digital frames with the movement of the transparent sheet.

3. The system of claim 2, wherein the line-scan sensor system further includes a computer operably connected to the frame grabber and that assembles the linear digital frames from the frame grabber to form the interference image.

4. The system of claim 3, wherein the computer is configured with instructions embodied in a computer-readable medium that cause the computer to process the at least one coherent defect signature of the interference image to calculate an amount of optical power redistribution caused by the at least one defect.

5. The system of claim 4, wherein the laser system includes at least one diode laser.

6. The system of claim 1, wherein the transparent sheet comprises glass.

7. The system of claim 1, wherein at least one of the front and back surfaces of the transparent sheet has a curvature.

8. The system of claim 1, wherein the cylindrical optical system consists of a single cylindrical optical element.

9. The system of claim 8, wherein the single cylindrical optical element is a plano-convex cylindrical lens.

10. A non-imaging coherent line-scanner system for characterizing at least one defect of a transparent sheet, consisting essentially of:
a laser system that generates a coherent diverging laser-line beam along an optical axis;
a cylindrical optical system arranged along the optical axis and that receives the diverging laser-line beam and forms therefrom a collimated laser-line beam;
a movable support member adapted to support and move the transparent sheet in a direction generally perpendicular to the optical axis; and
a line-scan sensor system arranged relative to the movable support member to define a working space, the line-scan sensor system being adapted to receive the collimated laser-line beam as transmitted through the transparent sheet and through the at least one defect without passing through any optical elements with power in the working space, and form from the transmitted collimated laser-line beam an interference image having at least one coherent defect signature corresponding to the at least one defect.

11. The system according to claim 10, wherein the line-scan sensor system includes a line-scan sensor, a frame-grabber operably connected to the line-scan sensor, and a computer operably connected to the frame grabber.

12. The system of according to claim 10, wherein the cylindrical optical system consists of a single cylindrical lens element.

13. The system according to claim 10, wherein the transparent sheet comprises glass.

14. A non-imaging method of detecting at least one defect in a transparent sheet, comprising:
transmitting a coherent laser-line beam through the transparent sheet while translating the transparent sheet in a direction generally perpendicular to the laser-line beam;
receiving and detecting the transmitted coherent laser-line beam with a line-scan sensor system that defines a working space between the line-scan sensor system and the transparent sheet, wherein the transmitted coherent laser-line beam passes through the at least one defect and the working space so that the line-scan sensor system forms an interference image that includes at least one coherent defect signature, and wherein there are no optical components that have optical power within the working space; and
determining from the at least one coherent defect signature one or more characteristics of the at least one defect.

15. The method according to claim 14, wherein the laser-line beam is fully collimated.

16. The method according to claim 15, further comprising forming the fully collimated laser-line beam by passing a divergent laser-line beam through a cylindrical optical system.

17. The method of claim 16, wherein the cylindrical optical system consists of a single cylindrical optical element.

18. The method according to claim 14, wherein the one or more characteristics includes at least one of a size, a shape and a location of the at least one defect.

19. The method according to claim 14, further including:
making a background measurement either without the transparent sheet or with a reference transparent sheet; and
subtracting the background measurement from the interference image.

20. The method according to claim 14, wherein the line-scan sensor system includes a line-scan sensor and a frame grabber, and wherein the method includes using the frame grabber to coordinate capturing with the line-scan sensor linear digital frames with the translating of the transparent sheet, and further including combining the linear digital frames to form the interference image.
